(19) United States
(12) Patent Application Publication
(10) Pub. No.: US 2026/0342102 A1
(43) Pub. Date: Oct. 29, 2026

(54) PASSIVITY-BASED DISTRIBUTED COORDINATED CONTROL METHOD FOR GRID-FORMING INVERTER STATION

(71) Applicant: HEFEI UNIVERSITY OF TECHNOLOGY, Hefei (CN)

(72) Inventors: Ming LI, Hefei (CN); Enjun LIU, Hefei (CN); Yongtao MAO, Hefei (CN); Xing WANG, Hefei (CN); Xing ZHANG, Hefei (CN); Hua GENG, Hefei (CN); Xiuqiang HE, Hefei (CN); Yangjun XIAO, Hefei (CN)

(73) Assignee: HEFEI UNIVERSITY OF TECHNOLOGY, Hefei (CN)

(21) Appl. No.: 19/359,742

(22) Filed: Oct. 16, 2025

(30) Foreign Application Priority Data
Apr. 27, 2025 (CN) 202510541977.2

(51) Int. Cl. H02J 3/466; H02J 3/0014; H02J 101/20; H02J 103/35

(52) U.S. Cl. CPC H02J 3/472; H02J 3/00142; H02J 2101/20; H02J 2103/35

(57) ABSTRACT

A passivity-based distributed coordinated control method for a grid-forming inverter station is provided. The distributed coordinated control method designs an inner-loop controller of a grid-forming inverter by using a port-controlled Hamiltonian method, and introduces a nonlinear observer to ensure stability of a renewable energy station. Furthermore, a pole placement method is employed to determine ideal damping injection parameters for each grid-forming inverter under different grid states, thereby improving dynamic performance of the grid-forming inverter station. The distributed coordinated control method is simple to implement, and solves a problem that in a multi-inverter scenario within the grid-forming inverter station, traditional passivity-based inverter control makes it difficult to balance overall dynamic performance of the inverter station, thereby effectively enhancing dynamic performance of the inverter station under a complex grid change.

### CROSS REFERENCE TO THE RELATED APPLICATIONS

This application is based upon and claims priority to Chinese Patent Application No. 202510541977.2, filed on Apr. 27, 2025, the entire contents of which are incorporated herein by reference.

### TECHNICAL FIELD

The present disclosure belongs to the field of electrical engineering, and relates to a passivity-based distributed coordinated control method for a grid-forming inverter station.

### BACKGROUND

A grid-connected inverter serves as a key interface for power generation of grid-connected renewable energy, and its control performance is of vital importance for a multi-inverter power station. Currently, many researchers have proposed control for grid-forming inverters. These inverters can support grid frequency and voltage and have become a prominent field of current research and a key trend in the development of large-scale renewable energy integration. At present, these inverters typically employ a linear controller, such as proportional-integral (PI) controller, which is designed based on a linear theory. However, when a nonlinear change occurs in a grid due to instability and volatility of renewable energy, such as plug-and-play of an inverter in the multi-inverter power station, a significant fluctuation in grid impedance, a random change in an operating point of the inverter, grid structure, and parameter change stochastically. In this case, a control scheme based on the linear theory may fail to ensure system stability. Previous studies have shown that problems such as broadband oscillation in a nonlinear frequency domain may arise, posing a significant challenge to the stability.

The article titled “Review on Grid-following/Grid-forming Hybrid Mode Control for Grid-connected Converter in High Penetration Rate of Renewable Energy Generation” (Xing Zhang, Xiangdui Zhan, Mengze Wu, et al Review on Grid-following Grid-forming Hybrid Mode Control for Grid-connected Converter in High Penetration Rate of Renewable Energy Generation[J]. Automation of Electric Power Systems, 2024, 48(21): 1-15) discusses characteristics of grid-following and grid-forming control for the inverter. In the context of renewable energy with a high penetration rate, a renewable energy station is often located in a weak grid environment at a grid periphery. Traditional grid-following grid-connected control of the inverter exhibits poor stability, whereas grid-forming grid-connected control demonstrates better stability. However, when the grid structure and parameter stochastically change within a wide range, the grid-forming grid-connected control still faces a challenge in maintaining stable operation, and problems such as resonance and instability of the multi-inverter power station within the renewable energy station still exist. The multi-inverter power station employing the traditional grid-forming grid-connected control is prone to nonlinear oscillation and cannot guarantee stability under a nonlinear disturbance.

To address high grid impedance and a nonlinear grid structure/parameter change, existing research has proposed passivity-based control grounded in a nonlinear control theory. However, the passivity-based control is not suitable for distributed coordinated control of a plurality of inverters in a grid-forming inverter station. For example:

1. The article titled “Distributed Coordinated Control for Stabilization of Multi-Inverter Power Plant (M. Li, H. Geng and X. Zhang, “Distributed Coordinated Control for Stabilization of Multi-Inverter Power Plant,” in IEEE Transactions on Industrial Electronics, vol. 70, no. 12, pp. 12421-12430, December 2023” designed a passivity-based controller for a grid-following inverter, achieving distributed coordinated stable operation of a grid-following inverter station and adapting to the nonlinear grid structure/parameter change. However, design of a corresponding passivity-based controller for grid-forming inverter control remains unexplored.

2. The Chinese patent document CN118264144B, which was authorized and published on May 6, 2025, and titled “Data-Driven Parameter Optimization Method for Grid-Forming Passivity-Based Control of Grid-Connected Inverter”, designed a passivity-based controller for the grid-forming inverter and employs a particle swarm optimization algorithm to optimize a damping injection parameter. However, the patent only addresses control parameters of a single inverter and cannot be applied to the grid-forming inverter station composed of a plurality of grid-forming inverters, failing to ensure a coordinated effect among the grid-forming inverters.

3. The Chinese patent document CN116404691A, which was published on Jul. 7, 2023 and titled “Control Parameter Optimization Method and Apparatus for Grid-Forming Renewable Energy Generation System”, designed a passivity-based controller for the grid-forming inverter and uses a D-partition method for parameter design. Similarly, the patent only involves control parameter design of a single inverter and is not applicable to the grid-forming inverter station.

In conclusion, there have been the following problems in the prior art:

(1) The grid-forming inverter control in the prior art lacks a capability to address nonlinear state and parameter changes of the grid and is difficult to balance control performance of individual inverters especially in the multi-inverter station.

(2) The proposed nonlinear distributed passivity-based control strategy for the multi-inverter station in the prior art is only used for the grid-following inverter, leaving a gap in designing the passivity-based control for the grid-forming inverter.

### SUMMARY

A technical problem to be solved in the present disclosure is: Traditional grid-forming control struggles to address nonlinear state and parameter changes of a grid, and it is difficult to coordinate dynamic performance among a plurality of inverters within a station. Therefore, there is a need to propose nonlinear grid-forming distributed coordinated control.

The objective of the present disclosure is achieved as follows: The present disclosure provides a passivity-based distributed coordinated control method for a grid-forming inverter station, where the grid-forming inverter station is a power generation station including n grid-forming inverters with identical structures, each of the n grid-forming inverters includes a direct current (DC)-side power supply, a three-phase inverter, and an inductor-capacitor (LC) filter that are sequentially connected in series, and output terminals of the n grid-forming inverters are connected in parallel and then connected to a three-phase grid through a grid inductor; and the passivity-based distributed coordinated control method includes the following steps:
step 1: establishing a mathematical model for inner voltage and current loops of a grid-forming inverter, and denoting the mathematical model as an inner-loop mathematical model;
step 2: establishing a port-controlled Hamiltonian model for an inner loop of the grid-forming inverter based on the inner-loop mathematical model in the step 1, denoting the port-controlled Hamiltonian model as an inner-loop Hamiltonian model, and defining an interconnection matrix J(x), a damping matrix R(x), and a Hamiltonian function H(x), where x represents a state variable matrix;
step 3: defining a nonlinear observer loop based on a port-controlled Hamiltonian form, and denoting the nonlinear observer loop as a nonlinear observer;
step 4: establishing an expected interconnection matrix J_{d}(x) and an expected damping matrix R_{d}(x):

$$\{ \begin{matrix}{J}_{d} ( x ) = J ( x ) + {J}_{a} ( x ) \\ {R}_{d} ( x ) = R ( x ) + {R}_{a} ( x )\end{matrix} ;$$

where Jₐ(x) represents an injected interconnection matrix, and Rₐ(x) represents an injected damping matrix, where the injected damping matrix Rₐ(x) is related to injected damping r₁ of a voltage loop and injected damping r₂ of a current loop, and the injected damping r₁ of the voltage loop and the injected damping r₂ of the current loop are undetermined parameters;
step 5: defining the state variable matrix x, an expected state variable matrix x_{d}, and a closed loop Hamiltonian function H_{d}(x−x_{d});
step 6: establishing an expected closed loop Hamiltonian model based on the inner-loop Hamiltonian model, the nonlinear observer, and the closed loop Hamiltonian function, where an expression of the expected closed loop Hamiltonian model is as follows:

$$\dot{x} - {\dot{x}}_{d} = [ {J}_{d} ( x ) - {R}_{d} ( x ) ] \frac{\partial {H}_{d} ( x - {x}_{d} )}{\partial ( x - {x}_{d} )} - {g}_{p} ( \hat{p} - p ) ;$$

where \dot{x} represents a differential of the state variable matrix, and \dot{x}_{d} represents a differential of the expected state variable matrix; and
designing a passivity-based controller for the inner voltage and current loops of the grid-forming inverter based on the expected closed loop Hamiltonian model, such that the grid-forming inverter station satisfies passivity, ensuring stable operation of the grid-forming inverter station; and
step 7: designing a parameter adaptation law for the injected damping r₁ of the voltage loop and the injected damping r₂ of the current loop by using a pole placement method, achieving distributed coordinated control among the n grid-forming inverters in the grid-forming inverter station, and optimizing dynamic performance of the grid-forming inverter station.

Preferably, an expression of the inner-loop mathematical model in the step 1 is as follows:

$$\{ \begin{matrix}L \frac{{di}_{d}}{dt} = - {r}_{f} {i}_{d} + ω {Li}_{q} + {v}_{d} - {v}_{Cd} - {γ}_{vd} \\ L \frac{{di}_{q}}{dt} = - {r}_{f} {i}_{q} - ω {Li}_{d} + {v}_{q} - {v}_{Cq} - {γ}_{vq} \\ C \frac{{dv}_{Cd}}{dt} = {i}_{d} - {i}_{gd} + ω {Cv}_{Cq} - {γ}_{id} \\ C \frac{{dv}_{Cq}}{dt} = {i}_{q} - {i}_{gq} - ω {Cv}_{Cd} - {γ}_{iq}\end{matrix} ;$$

where L represents an inductance value of a filtering inductor, C represents a capacitance value of a filtering capacitor, i_{d} represents a d-axis component of an output current of an inverter, i_{q} represents a q-axis component of the output current of the inverter,

$$\frac{{di}_{d}}{dt}$$

represents a derivative of the d-axis component of the output current of the inverter with respect to time,

$$\frac{{di}_{q}}{dt}$$

represents a derivative of the q-axis component of the output current of the inverter with respect to the time, v_{Cd} represents a d-axis component of an output voltage of the inverter, v_{Cq} represents a q-axis component of the output voltage of the inverter,

$$\frac{{dv}_{d}}{dt}$$

represents a derivative of the d-axis component of the output voltage of the inverter with respect to the time,

$$\frac{{dv}_{q}}{dt}$$

represents a derivative of the q-axis component of the output voltage of the inverter with respect to the time, ω represents an angular frequency, i_{gd} represents a d-axis component of a grid-side current, i_{gq} represents a q-axis component of the grid-side current, r_{f} represents a parasitic resistance value of the filtering inductor, v_{d} represents a d-axis component of a modulation voltage of the inverter, v_{q} represents a q-axis component of the modulation voltage of the inverter, γ_{vd} represents a d-axis component of a disturbance of the voltage loop, γ_{vq} represents a q-axis component of the disturbance of the voltage loop, γ_{id} represents a d-axis component of a disturbance of the current loop, and γ_{iq} represents a q-axis component of the disturbance of the current loop.

Preferably, an expression of the inner-loop Hamiltonian model in the step 2 is as follows:

$$\dot{x} = [ J ( x ) - R ( x ) ] \frac{\partial H ( x )}{\partial x} + {g}_{c} {u}_{c} + {g}_{e} {u}_{e} + {g}_{p} p ;$$

where u_{c} represents a control input matrix, g_{c} represents a coefficient matrix of the control input matrix, uₑ represents an external input matrix, gₑ represents a coefficient matrix of the external input matrix, p represents an unknown disturbance matrix, gₚ represents a coefficient matrix of the unknown disturbance matrix, H(x) represents the Hamiltonian function, J(x) represents the interconnection matrix, and R(x) represents the damping matrix;
expressions of the interconnection matrix J(x) and the damping matrix R(x) are as follows:

$$J ( x ) = [ \begin{matrix}0 & ω / L & - 1 / ( LC ) & 0 \\ - ω / L & 0 & 0 & - 1 / ( LC ) \\ 1 / ( LC ) & 0 & 0 & ω / C \\ 0 & 1 / ( LC ) & - ω / C & 0\end{matrix} ] ; \\ R ( x ) = ( \begin{matrix}{r}_{f} / {L}^{2} & 0 & 0 & 0 \\ 0 & {r}_{f} / {L}^{2} & 0 & 0 \\ 0 & 0 & 0 & 0 \\ 0 & 0 & 0 & 0\end{matrix} ) ;$$

the Hamiltonian function H(x) is defined as follows:

$$H ( x ) = \frac{1}{2} {Li}_{d}^{2} + \frac{1}{2} {Li}_{q}^{2} + \frac{1}{2} {Cv}_{Cd}^{2} + \frac{1}{2} {Cv}_{Cq}^{2} .$$

Preferably, an expression of the nonlinear observer in the step 3 is as follows:

$$\{ \begin{matrix}\hat{x} = [ {J}_{d} ( x ) - {R}_{d} ( x ) ] \frac{\partial H ( x )}{\partial x} + {g}_{c} {u}_{c} + {g}_{e} {u}_{e} + {g}_{p} \hat{p} - {k}_{1} ( \hat{x} - x ) \\ \dot{\hat{p}} = ( - {k}_{1} {k}_{2} - {g}_{p} ) ( \hat{x} - x ) - {k}_{2} ( {x}^{\dot{ˆ}} - \dot{x} ) + {g}_{p} \frac{\partial {H}_{d} ( x - {x}_{d} )}{\partial ( x - {x}_{d} )}\end{matrix} ;$$

where \hat{x} represents an observed value of the state variable matrix, \hat{\dot{x}} represents a differential of the observed value of the state variable matrix, \hat{p} represents an observed value of the unknown disturbance matrix, \hat{\dot{p}} represents a differential of the observed value of the unknown disturbance matrix, k₁ represents a first observer gain coefficient, k₂ represents a second observer gain coefficient, J_{d}(x) represents the expected interconnection matrix, and R_{d}(x) represents the expected damping matrix.

Preferably, the injected interconnection matrix Jₐ(x) and the injected damping matrix Rₐ(x) in the step 4 are defined as follows:

$$\{ \begin{matrix}{J}_{a} ( x ) = 0 \\ {R}_{a} ( x ) = ( \begin{matrix}{r}_{1} / {L}^{2} & 0 & 0 & 0 \\ 0 & {r}_{1} / {L}^{2} & 0 & 0 \\ 0 & 0 & {r}_{2} / {C}^{2} & 0 \\ 0 & 0 & 0 & {r}_{2} / {C}^{2}\end{matrix} )\end{matrix} .$$

Preferably, the state variable matrix x, the expected state variable matrix x_{d}, and the closed loop Hamiltonian function H_{d}(x−x_{d}) in the step 5 are defined as follows:

$$\{ \begin{matrix}x = {( {i}_{d} , {i}_{q} , {v}_{Cd} , {v}_{Cq} )}^{T} \\ {x}_{d} = {( {i}_{d}^{*} , {i}_{q}^{*} , {v}_{Cd}^{*} , {v}_{Cq}^{*} )}^{T}\end{matrix} ; \\ {H}_{d} ( x - {x}_{d} ) = \frac{1}{2} {( x - {x}_{d} )}^{T} Q ( x - {x}_{d} ) ;$$

where

$${i}_{d}^{*}$$

represents an expected d-axis component of the output current of the inverter,

$${i}_{q}^{*}$$

represents an expected q-axis component of the output current of the inverter,

$${v}_{Cd}^{*}$$

represents an expected d-axis component of the output voltage of the inverter,

$${v}_{Cq}^{*}$$

represents an expected q-axis component of the output voltage of the inverter, the superscript T represents matrix transposition, Q represents a filter parameter matrix, and Q=diag(L,L,C,C).

Preferably, the step 7 specifically includes following steps:

step 7.1: establishing a voltage-loop open loop continuous domain transfer function Gᵥ(s) and a current-loop open loop continuous domain transfer function G_{c}(s) of the passivity-based controller for the inner voltage and current loops, where expressions of the voltage-loop open loop continuous domain transfer function and the current-loop open loop continuous domain transfer function are as follows:

$$\{ \begin{matrix}{G}_{v} ( s ) = {r}_{1} + sC \\ {G}_{c} ( s ) = {r}_{2} + sL\end{matrix} ;$$

where s represents a Laplace operator; and
multiplying the Gᵥ(s) and the G_{c}(s) to obtain an overall open loop continuous domain transfer function Gᵢ(s) of the passivity-based controller for the inner voltage and current loops, where an expression of the overall open loop continuous domain transfer function is as follows:

Gᵢ(s)=Gᵥ(s)·G_{c}(s)=r₁r₂+(r₁L+r₂C)s+LCs²;

step 7.2: discretizing the overall open loop continuous domain transfer function Gᵢ(s) of the passivity-based controller for the inner voltage and current loops by using a backward Euler method, and obtaining an overall open loop discrete domain transfer function Gᵢ(z) of the passivity-based controller for the inner voltage and current loops, where an expression of the overall open loop discrete domain transfer function is as follows:

$${G}_{i} ( z ) = [ {r}_{1} {r}_{2} {T}_{s}^{2} + ( {r}_{1} L + {r}_{2} C ) ( 1 - {z}^{- 1} ) {T}_{s} + {LC ( 1 - {Z}^{- 1} )}^{2} ] / {T}_{s}^{2} ;$$

where Tₛ represents a sampling period, z represents a discrete domain variable, z=e^{-sT}^{ₛ}, and s represents the Laplace operator;
step 7.3: establishing a discrete domain transfer function G_{LCL}(z) of an inverter-side current with respect to the output voltage of the inverter, where an expression of the discrete domain transfer function is as follows:

$${G}_{LCL} = \frac{a ( {z}^{- 1} - 2 {z}^{- 2} b + {z}^{- 3} )}{1 + ( 2 cos {ω}_{r} {T}_{s} + 1 ) ( - {z}^{- 1} + {z}^{- 2} ) - {z}^{- 3}} ;$$

where ωᵣ represents a resonant frequency, namely

$${ω}_{r} = \sqrt{\frac{L + {L}_{g}}{{LL}_{g} C}} ;$$

a represents a first simplification coefficient, namely

$$a = \frac{L {ω}_{r} {T}_{s} + {L}_{g} sin {ω}_{r} {T}_{s}}{{ω}_{r} L ( + L + {L}_{g} )}$$

b represents a second simplification coefficient, namely

$$b = \frac{L {ω}_{r} {T}_{s} cos {ω}_{r} {T}_{s} + {L}_{g} sin {ω}_{r} {T}_{s}}{L {ω}_{r} {T}_{s} + {L}_{g} sin {ω}_{r} {T}_{s}} ;$$

and L_{g} represents an inductance value of the grid inductor;
step 7.4: calculating a closed loop discrete domain transfer function G(z) of the controller based on the overall open loop discrete domain transfer function Gᵢ(z) of the passivity-based controller for the inner voltage and current loops in the step 7.2, and the discrete domain transfer function G_{LCL}(z) of the inverter-side current with respect to the output voltage of the inverter in the step 7.3, where an expression of the closed loop discrete domain transfer function is as follows:

G(z)=z⁻¹Gᵢ(z)G_{LCL}(z)/[1+z⁻¹Gᵢ(z)G_{LCL}(z)];
step 7.5: obtaining a closed loop discrete domain characteristic equation A_{c}(z⁻¹) of the controller based on the closed loop discrete domain transfer function G(z) of the controller:

$${A}_{c} ( {z}^{- 1} ) = 1 - ( 2 cos {ω}_{n} {T}_{s} + 1 ) {z}^{- 1} + ( 1 + 2 cos {ω}_{n} {T}_{s} + {ar}_{1} {r}_{2} + a ( {r}_{1} L + {r}_{2} C ) / {T}_{s} + aLC / {T}_{s}^{2} ) {z}^{- 2} + ( - 1 - 2 ab ( {r}_{1} {r}_{2} + ( {r}_{1} L + {r}_{2} C ) / {T}_{s} + LC / {T}_{s}^{2} ) - a ( {r}_{1} L + {r}_{2} C ) / {T}_{s} - 2 aLC / {T}_{s}^{2} ) {z}^{- 3} + ( a ( {r}_{1} {r}_{2} + ( {r}_{1} L + {r}_{2} C ) / {T}_{s} + LC / {T}_{s}^{2} ) + 2 ab ( {r}_{1} L + {r}_{2} C ) / {T}_{s} + ( 4 ab + a ) LC / {T}_{s}^{2} ) {z}^{- 4} + ( - a ( {r}_{1} L + {r}_{2} C ) / {T}_{s} - ( 2 a + 2 ab ) LC / {T}_{s}^{2} ) {z}^{- 5} + ( aLC / {T}_{s}^{2} ) {z}^{- 6} ;$$

step 7.6: selecting an expected pole of the closed loop discrete domain characteristic equation of the controller, and defining a first dominant pole z₁, a second dominant pole z₂, a third non-dominant pole z₃, a fourth non-dominant pole z₄, a fifth non-dominant pole z₅, and a sixth non-dominant pole z₆ that are expressed are as follows:

$$\{ \begin{matrix}{z}_{1} = {e}^{- {ξω}_{n} {T}_{s}} [ cos ( {ω}_{n} {T}_{s} \sqrt{1 - {ξ}^{2}} ) + j sin ( {ω}_{n} {T}_{s} \sqrt{1 - {ξ}^{2}} ) ] \\ {z}_{2} = {e}^{- {ξω}_{n} {T}_{s}} [ cos ( {ω}_{n} {T}_{s} \sqrt{1 - {ξ}^{2}} ) - j sin ( {ω}_{n} {T}_{s} \sqrt{1 - {ξ}^{2}} ) ] \\ {z}_{3} = {e}^{- m {ξω}_{n} {T}_{s}} \\ {z}_{4} = {e}^{- m {ξω}_{n} {T}_{s}} \\ {z}_{5} = {e}^{- m {ξω}_{n} {T}_{s}} \\ {z}_{6} = {e}^{- m {ξω}_{n} {T}_{s}}\end{matrix}$$

where ξ represents a damping ratio, ωₙ represents a natural frequency, j represents an imaginary unit, and m represents a non-dominant pole coefficient;
step 7.7: obtaining an expected closed loop discrete domain characteristic equation Aₘ(z⁻¹) of the controller based on the expected pole of the discrete domain characteristic equation in the step 7.6, where an expression of the expected closed loop discrete domain characteristic equation is as follows:

Aₘ(z⁻¹)=[z²−2e^{-ξω}^{ₙ}^{T}^{ₛ} cos(ωₙ\sqrt{1−ξ²}Tₛ)z+e^{-2ξω}^{ₙ}^{T}^{ₛ}](z−e^{-mξω}^{ₙ}^{T}^{ₛ})⁴;
step 7.8: based on the closed loop discrete domain characteristic equation of the controller in the step 7.5 and the expected closed loop discrete domain characteristic equation of the controller in the step 7.7, setting Aₘ(z⁻¹)=A_{c}(z⁻¹), implementing pole placement, and establishing a mathematical relationship between the injected damping r₁ of the voltage loop, the injected damping r₂ of the current loop, and the L_{g} of the grid inductor;
assuming that the injected damping r₂ of the current loop and the L_{g} of the grid inductor are known quantities, deriving two types of constraint relationships of the injected damping of the voltage loop with respect to the r₁, and defining a first constraint relationship as r₁=f(r₂,L_{g}), where an expression of the first constraint relationship is as follows:

$${r}_{1} = \frac{{e}^{- 2 {ξω}_{n} {T}_{s}} + 8 {e}^{- ( 1 + m ) {ξω}_{n} {T}_{s}} cos ( {ω}_{n} {T}_{s} \sqrt{1 - {ξ}^{2}} ) + 6 {e}^{- 2 m {ξω}_{n} {T}_{s}} - ( 1 + 2 cos ( {ω}_{r} {T}_{s} ) + \frac{aLC}{{T}_{s}^{2}} + \frac{{ar}_{2} C}{{T}_{S}} )}{{ar}_{2} + aL / {T}_{s}} ;$$

defining a second constraint relationship as r₁=g(r₂,L_{g}), where an expression of the second constraint relationship is as follows:

$${r}_{1} = \frac{12 {e}^{- ( 2 m + 1 ) {ξω}_{n} {T}_{s}} cos ( {ω}_{n} \sqrt{1 - {ξ}^{2}} {T}_{s} ) + 4 {e}^{- ( m + 2 ) {ξω}_{n} {T}_{s}} + 4 {e}^{- 3 m {ξω}_{n} {T}_{s}} + 1 + \frac{2 {abr}_{2} C}{{T}_{s}} + \frac{2 abLC}{{T}_{s}^{2}} + \frac{{ar}_{2} C}{{T}_{s}} + \frac{2 aLC}{{T}_{s}^{2}}}{2 {abr}_{2} + 2 abL / {T}_{s} + aL / {T}_{s}} ;$$

step 7.9: based on the two types of constraint relationships r₁=f(r₂,L_{g}) and r₁=g(r₂,L_{g}) in the step 7.8, calculating corresponding values that are of the r₁ and the r₂ and satisfy expected dynamic performance of each grid-forming inverter in the grid-forming inverter station under corresponding different L_{g} of the grid inductor, thereby achieving the distributed coordinated control among the n grid-forming inverters.

Compared with the prior art, the present disclosure has the following beneficial effects:

1. A control method for a grid-forming inverter provided in the present disclosure is simple to implement, and only needs to adaptively adjust injected damping based on grid impedance after designing a controller to enhance dynamic performance of the grid-forming inverter.

2. A passivity-based controller designed based on a nonlinear theory in the present disclosure can ensure stability of the inverter under complex and nonlinear state and parameter changes of a grid, and its stability is superior to that of a controller designed under a traditional linear framework in a renewable energy grid with a high penetration rate.

3. The present disclosure introduces a nonlinear state observer in a controller for inner voltage and current loops of the grid-forming inverter, so as to effectively handle an external unknown disturbance of the inverter, thereby achieving error-free tracking of an output of the inverter. Moreover, the nonlinear state observer is designed based on passivity and remains stable all the time.

4. The passivity-based controller and the adaptive adjustment method for the injected damping in the present disclosure are designed from a multi-machine perspective. In an inverter station with a large number of grid-forming inverters, distributed coordinated control can be achieved for the grid-forming inverters, thereby reducing mutual interference among the grid-forming inverters and ensuring that the inverter station has good dynamic performance.

### BRIEF DESCRIPTION OF THE DRAWINGS

FIG. 1 is a structural diagram of a grid-forming inverter station according to the present disclosure;

FIG. 2 is an overall control block diagram of a distributed coordinated control method according to the present disclosure;

FIG. 3 is a control block diagram of a nonlinear state observer according to the present disclosure;

FIG. 4 is a control block diagram of a passivity-based controller for inner voltage and current loops of a grid-forming inverter according to the present disclosure;

FIG. 5 is a curve graph illustrating a relationship between a value of injected damping and grid inductance according to the present disclosure;

FIG. 6 shows a simulation waveform when a fixed damping injection control method is employed; and

FIG. 7 shows a simulation waveform when a distributed coordinated control method in the present disclosure is employed.

### DETAILED DESCRIPTION OF THE EMBODIMENTS

The technical solutions in the present disclosure will be clearly and completely described below with reference to the accompanying drawings.

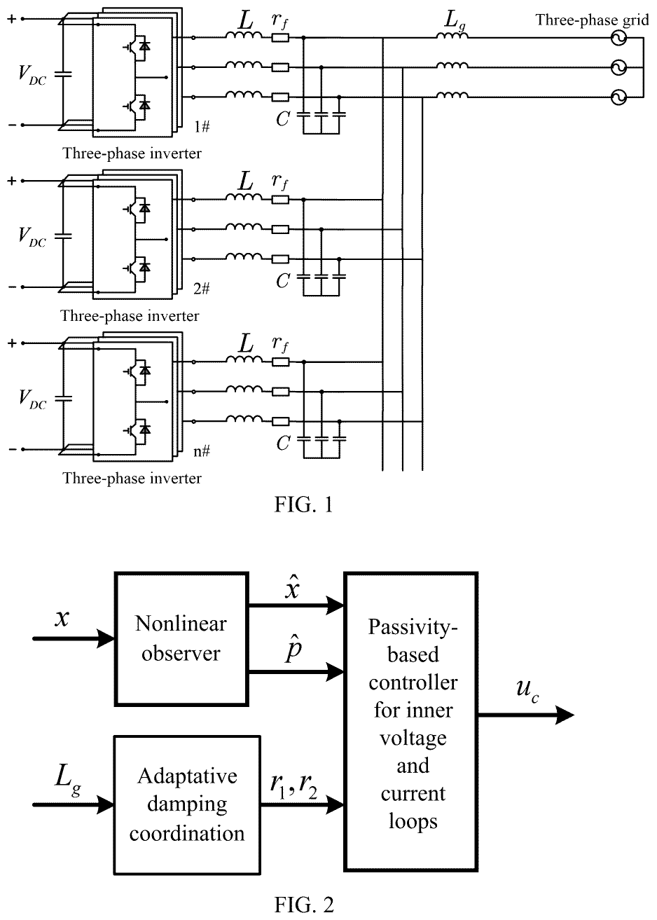

FIG. 1 is a structural diagram of a grid-forming inverter station according to the present disclosure. As shown in FIG. 1, the grid-forming inverter station is a power generation station including n grid-forming inverters with identical structures, where each of the n grid-forming inverters includes a DC-side power supply, a three-phase inverter, and an LC filter that are sequentially connected in series, and output terminals of the n grid-forming inverters are connected in parallel and then connected to a three-phase grid through a grid inductor.

In FIG. 1, V_{DC} represents a DC-side voltage, 1 # represents a serial number of a first inverter, 2 # represents a serial number of a second inverter, n # represents a serial number of an n^{th} inverter, L represents an inductance value of a filtering inductor, r_{f} represents a parasitic resistance value of the filtering inductor, C represents a capacitance value of a filtering capacitor, and L_{g} represents an inductance value of the grid inductor. In this embodiment of the present disclosure, V_{DC}=800V, L=1 mH, r_{f}=0.1Ω, C=10 μF, and L_{g}=5 mH.

FIG. 2 is an overall control block diagram of a distributed coordinated control method according to the present disclosure. As shown in FIG. 2, a passivity-based distributed coordinated control method for a grid-forming inverter station in the present disclosure is divided into three main parts. State variable matrix x is input into a nonlinear observer to obtain observed value \hat{x} of the state variable matrix and observed value \hat{p} of an unknown disturbance matrix, which are then input into a passivity-based controller for inner voltage and current loops. Inductance value L_{g} of a grid inductor is input into an adaptive damping coordination loop to obtain injected damping r₁ and injected damping r₂, which are then input into the passivity-based controller for the inner voltage and current loops. Finally, the passivity-based controller for the inner voltage and current loops outputs control input matrix u_{c}, and the u_{c} is used as a control signal and input into a corresponding three-phase inverter in FIG. 1 to control the three-phase inverter. The distributed coordinated control method specifically includes following steps:

Step 1: A port-controlled Hamiltonian model for an inner loop of a grid-forming inverter is established and denoted as an inner-loop Hamiltonian model; and interconnection matrix J(x), damping matrix R(x), and Hamiltonian function H(x) are defined, where x represents the state variable matrix, u_{c} represents the control input matrix, g_{c} represents a coefficient matrix of the control input matrix, uₑ represents an external input matrix, gₑ represents a coefficient matrix of the external input matrix, p represents the unknown disturbance matrix, and gₚ represents a coefficient matrix of the unknown disturbance matrix.

In this embodiment, an expression of the inner-loop Hamiltonian model is as follows:

$$\dot{x} = [ J ( x ) - R ( x ) ] \frac{\partial H ( x )}{\partial x} + {g}_{c} {u}_{c} + {g}_{e} {u}_{e} + {g}_{p} p ;$$

Expressions of the interconnection matrix J(x) and the damping matrix R(x) are as follows:

$$J ( x ) = [ \begin{matrix}0 & ω / L & - 1 / ( LC ) & 0 \\ - ω / L & 0 & 0 & - 1 / ( LC ) \\ 1 / ( LC ) & 0 & 0 & ω / C \\ 0 & 1 / ( LC ) & - ω / C & 0\end{matrix} ] ; \\ R ( x ) = ( \begin{matrix}{r}_{f} / {L}^{2} & 0 & 0 & 0 \\ 0 & {r}_{f} / {L}^{2} & 0 & 0 \\ 0 & 0 & 0 & 0 \\ 0 & 0 & 0 & 0\end{matrix} ) ;$$

The Hamiltonian function H(x) is defined as follows:

$$H ( x ) = \frac{1}{2} {Li}_{d}^{2} + \frac{1}{2} {Li}_{q}^{2} + \frac{1}{2} {Cv}_{Cd}^{2} + \frac{1}{2} {Cv}_{Cq}^{2} .$$

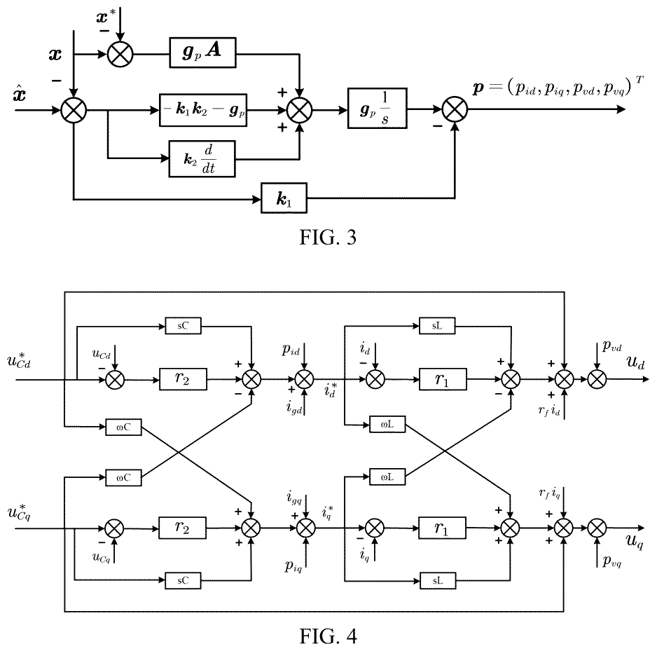

Step 2: A nonlinear observer loop is defined based on a port-controlled Hamiltonian form and denoted as the nonlinear observer. A control block diagram of the nonlinear observer is shown in FIG. 3.

In this embodiment, an expression of the nonlinear observer is as follows:

$$\{ \begin{matrix}{x}^{\dot{ˆ}} = [ {J}_{d} ( x ) - {R}_{d} ( x ) ] \frac{\partial H ( x )}{\partial x} + {g}_{c} {u}_{c} + {g}_{e} {u}_{e} + {g}_{p} \hat{p} - {k}_{1} ( \hat{x} - x ) \\ \dot{\hat{p}} = ( - {k}_{1} {k}_{2} - {g}_{p} ) ( \hat{x} - x ) - {k}_{2} ( {x}^{\dot{ˆ}} - \dot{x} ) + {g}_{p} \frac{\partial {H}_{d} ( x - {x}_{d} )}{\partial ( x - {x}_{d} )}\end{matrix} ;$$

where \hat{x} represents the observed value of the state variable matrix, \hat{\dot{x}} represents a differential of the observed value of the state variable matrix, \hat{p} represents the observed value of the unknown disturbance matrix, \hat{\dot{p}} represents a differential of the observed value of the unknown disturbance matrix, k₁ represents a first observer gain coefficient, k₂ represents a second observer gain coefficient, x_{d} presents an expected state variable matrix, H_{d}(x−x_{d}) represents a closed loop Hamiltonian function, J_{d}(x) represents an expected interconnection matrix, and R_{d}(x) represents an expected damping matrix.

In the embodiment, k₁=diag(5000,5000,10⁴), and k₂=diag(1,1,2).

Step 3: The expected interconnection matrix J_{d}(x) and the expected damping matrix R_{d}(x) are established:

$$\{ \begin{matrix}{J}_{d} ( x ) = J ( x ) + {J}_{a} ( x ) \\ {R}_{d} ( x ) = R ( x ) + {R}_{a} ( x )\end{matrix} ;$$

where Jₐ(x) represents an injected interconnection matrix, and Rₐ(x) represents an injected damping matrix, where the injected damping matrix Rₐ(X) is related to the injected damping r₁ of a voltage loop and the injected damping r₂ of a current loop, and the injected damping r₁ of the voltage loop and the injected damping r₂ of the current loop are undetermined parameters.

In this embodiment, the injected interconnection matrix Jₐ(x) and the injected damping matrix Rₐ(x) are defined as follows:

$$\{ \begin{matrix}{J}_{a} ( x ) = 0 \\ {R}_{a} ( x ) = ( \begin{matrix}{r}_{1} / {L}^{2} & 0 & 0 & 0 \\ 0 & {r}_{1} / {L}^{2} & 0 & 0 \\ 0 & 0 & {r}_{2} / {C}^{2} & 0 \\ 0 & 0 & 0 & {r}_{2} / {C}^{2}\end{matrix} )\end{matrix} .$$

Step 4: The state variable matrix x, the expected state variable matrix x_{d}, and the closed loop Hamiltonian function H_{d}(x−x_{d}) are defined.

In this embodiment, the state variable matrix x, the expected state variable matrix x_{d}, and the closed loop Hamiltonian function H_{d}(x−x_{d}) are defined as follows:

$$\{ \begin{matrix}x = {( {i}_{d} , {i}_{q} , {v}_{Cd} , {v}_{Cq} )}^{T} \\ {x}_{d} = {( {i}_{d}^{*} , {i}_{q}^{*} , {v}_{Cd}^{*} , {v}_{Cq}^{*} )}^{T}\end{matrix} ; \\ {H}_{d} ( x - {x}_{d} ) = \frac{1}{2} {( x - {x}_{d} )}^{T} Q ( x - {x}_{d} ) ;$$

where

$${i}_{d}^{*}$$

represents an expected d-axis component of an output current of an inverter,

$${i}_{q}^{*}$$

represents an expected q-axis component of the output current of the inverter,

$${v}_{Cd}^{*}$$

represents an expected d-axis component of an output voltage of the inverter,

$${v}_{Cq}^{*}$$

represents an expected q-axis component of the output voltage of the inverter, the superscript T represents matrix transposition, Q represents a filter parameter matrix, and Q=diag(L,L,C,C).

Step 5: An expected closed loop Hamiltonian model is based on the inner-loop Hamiltonian model, the nonlinear observer, and the closed loop Hamiltonian function, and its expression is as follows:

$$\dot{x} - {\dot{x}}_{d} = [ {J}_{d} ( x ) - {R}_{d} ( x ) ] \frac{\partial {H}_{d} ( x - {x}_{d} )}{\partial ( x - {x}_{d} )} - {g}_{p} ( \hat{p} - p ) ;$$

where \dot{x} represents a differential of the state variable matrix, and \dot{x}_{d} represents a differential of the expected state variable matrix.

The passivity-based controller for the inner voltage and current loops of the grid-forming inverter is designed based on the expected closed loop Hamiltonian model, as shown in FIG. 4, such that the grid-forming inverter station satisfies passivity, ensuring stable operation of the grid-forming inverter station.

Step 6: A parameter adaptation law for the injected damping r₁ of the voltage loop and the injected damping r₂ of the current loop is designed by using a pole placement method, distributed coordinated control is achieved among the plurality of grid-forming inverters in the grid-forming inverter station, and dynamic performance of the grid-forming inverter station is optimized.

In this embodiment, a result of the pole placement method in the step 6 is as follows:

ωᵣ is defined as a resonant frequency, namely

$${ω}_{r} = \sqrt{\frac{L + {L}_{g}}{{LL}_{g} C}} ;$$

a represents a first simplification coefficient, namely

$$a = \frac{L {ω}_{r} {T}_{s} + {L}_{g} sin {ω}_{r} {T}_{s}}{{ω}_{r} L ( L + {L}_{g} )} ;$$

b represents a second simplification coefficient, namely

$$b = \frac{L {ω}_{r} {T}_{s} cos {ω}_{r} {T}_{s} + {L}_{g} sin {ω}_{r} {T}_{s}}{L {ω}_{r} {T}_{s} + {L}_{g} sin {ω}_{r} {T}_{s}} ;$$

and L_{g} represents inductance value of the grid inductor.

Assuming that the injected damping r₂ of the current loop and the L_{g} of the grid inductor are known quantities, two types of constraint relationships of the injected damping of the voltage loop with respect to the r₁ are derived, and a first constraint relationship is defined as r₁=f(r₂,L_{g}) and its expression is as follows:

$${r}_{1} = \frac{\begin{matrix}{e}^{- 2 ξ {ω}_{n} {T}_{s}} + 8 {e}^{- ( 1 + m ) ξ {ω}_{n} {T}_{s}} cos ( {ω}_{n} {T}_{s} \sqrt{1 - {ξ}^{2}} ) + \\ 6 {e}^{- 2 m {ξω}_{n} {T}_{s}} - ( 1 + 2 cos ( {ω}_{r} {T}_{s} ) + \frac{aLC}{{T}_{s}^{2}} + \frac{{ar}_{2} C}{{T}_{s}} )\end{matrix}}{{ar}_{2} + aL / {T}_{s}} ;$$

A second constraint relationship is defined as r₁=g(r₂,L_{g}), and its expression is as follows:

$${r}_{1} = \frac{\begin{matrix}12 {e}^{- ( 2 m + 1 ) ξ {ω}_{n} {T}_{s}} cos ( {ω}_{n} \sqrt{1 - {ξ}^{2}} {T}_{s} ) + 4 {e}^{- ( m + 2 ) ξ {ω}_{n} {T}_{s}} + \\ 4 {e}^{- 3 m {ξω}_{n} {T}_{s}} + 1 + \frac{2 {abr}_{2} C}{{T}_{s}} + \frac{2 abLC}{{T}_{s}^{2}} + \frac{{ar}_{2} C}{{T}_{s}} + \frac{2 aLC}{{T}_{s}^{2}}\end{matrix}}{2 {abr}_{2} + 2 abL / {T}_{s} + aL / {T}_{s}} ;$$

Based on the two types of constraint relationships r₁=f(r₂,L_{g}) and r₁=g(r₂,L_{g}), corresponding values that are of the r₁ and the r₂ and satisfy expected dynamic performance of each grid-forming inverter in the grid-forming inverter station under corresponding different L_{g} of the grid inductor are calculated, thereby achieving the distributed coordinated control among the n grid-forming inverters.

In this embodiment, sampling time Tₛ=10⁻⁴ s, damping ratio ξ=0.707, natural frequency ωₙ=314 rad/s, and non-dominant pole coefficient m=10 are taken.

To substantiate the passivity-based distributed coordinated control method for a grid-forming inverter station in the present disclosure, simulation is carried out.

In the simulation, n=2, meaning that two three-phase inverters are used for verification, which are respectively denoted as inverter 1 and inverter 2. A relevant electrical parameter setting for the simulation is as follows: power reference value

$${P}_{1}^{*} = 20 kW$$

for the inverter 1 and active power reference value

$${P}_{2}^{*} = 10 kW$$

for the inverter 2. The inverter 1 and the inverter 2 are controlled through a control signal processor. The control signal processor includes a microprocessor and a memory that are connected to each other. The microprocessor is programmed or configured to execute the steps of the passivity-based distributed coordinated control method for a grid-forming inverter station, thereby controlling a grid-connected inverter rapidly and in real time. The memory includes a computer-readable storage medium, and the computer-readable storage medium stores a computer program that is programmed or configured to execute the passivity-based distributed coordinated control method for a grid-forming inverter station.

FIG. 5 is a curve graph illustrating relationships between values of injected damping of the inverter 1 and the inverter 2 and grid inductance under the corresponding parameters. Different grid inductance corresponds to different values of injected damping r₁ of a voltage loop and different values of injected damping r₂ of a current loop.

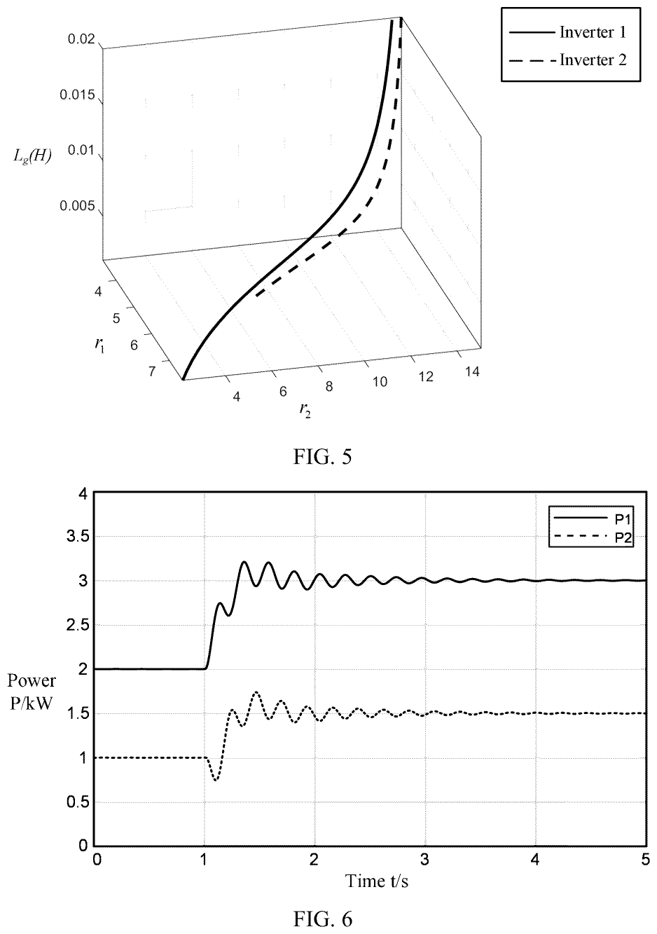

FIG. 6 shows power waveforms when same fixed damping injection parameters are used for the injected damping of the inverter 1 and the inverter 2, to compare an effect of the passivity-based distributed coordinated control method for a grid-forming inverter station in the present disclosure. The fixed damping injection parameters are r₁=1 and r₂=2. At 1 s, the active power reference value of the inverter 1 and the active power reference value of the inverter 2 are simulated, and it is found that a disturbance increases abruptly. Specifically, the active power reference value of the inverter 1 becomes 30 kW, and the active power reference value of the inverter 2 becomes 15 kW. As can be seen from FIG. 6, an active power waveform oscillates obviously.

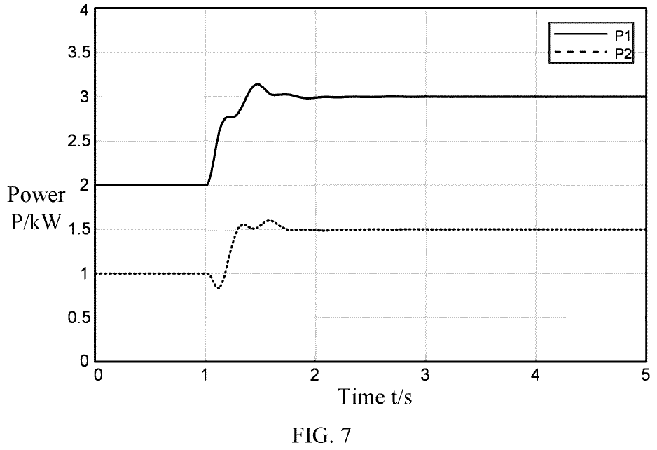

FIG. 7 shows a power waveform when the injected damping of the inverter 1 and the inverter 2 is adaptively given by using the distributed coordinated control method of the present disclosure. A damping parameter is given by the corresponding curve in FIG. 5. At 1 s, the active power reference value of the inverter 1 and the active power reference value of the inverter 2 are simulated, and it is found that the disturbance increases abruptly. Specifically, the active power reference value of the inverter 1 becomes 30 kW, and the active power reference value of the inverter 2 becomes 15 kW. As can be seen from FIG. 7, the oscillation of the active power waveform has been effectively suppressed.

In conclusion, the simulation waveforms shown in FIG. 6 and FIG. 7 are in line with a result of the present disclosure. The proposed passivity-based distributed coordinated control method for a grid-forming inverter station in the present disclosure effectively suppresses active power oscillation under a system disturbance and improves dynamic performance of a system.

What is claimed is:

1-7. (canceled)

8. A passivity-based distributed coordinated control method for a grid-forming inverter station, wherein the grid-forming inverter station is a power generation station comprising n grid-forming inverters with identical structures, each of the n grid-forming inverters comprises a direct current (DC)-side power supply, a three-phase inverter, and an inductor-capacitor (LC) filter that are sequentially connected in series, and output terminals of the n grid-forming inverters are connected in parallel and then connected to a three-phase grid through a grid inductor; and the coordinated control method comprises following steps:
step 1: establishing a mathematical model for inner voltage and current loops of a grid-forming inverter, and denoting the mathematical model as an inner-loop mathematical model;
step 2: establishing a port-controlled Hamiltonian model for the inner loops of the grid-forming inverter based on the inner-loop mathematical model in the step 1, denoting the port-controlled Hamiltonian model as an inner-loop Hamiltonian model, and defining an interconnection matrix J(x), a damping matrix R(x), and a Hamiltonian function H(x), wherein x represents a state variable matrix;
step 3: defining a nonlinear observer loop based on a port-controlled Hamiltonian form, and denoting the nonlinear observer loop as a nonlinear observer;
step 4: establishing an expected interconnection matrix J_{d}(x) and an expected damping matrix R_{d}(x):
$$\{ \begin{matrix}{J}_{d} ( x ) = J ( x ) + {J}_{a} ( x ) \\ {R}_{d} ( x ) = R ( x ) + {R}_{a} ( x )\end{matrix} ;$$
wherein Jₐ(x) represents an injected interconnection matrix, and Rₐ(x) represents an injected damping matrix, Jₐ(x) and R (x) are defined as follows:
$$\{ \begin{matrix}{J}_{a} ( x ) = 0 \\ {R}_{a} ( x ) = ( \begin{matrix}{r}_{1} / {L}^{2} & 0 & 0 & 0 \\ 0 & {r}_{1} / {L}^{2} & 0 & 0 \\ 0 & 0 & {r}_{2} / {C}^{2} & 0 \\ 0 & 0 & 0 & {r}_{2} / {C}^{2}\end{matrix} )\end{matrix} ,$$
wherein r₁ represents injected damping of a voltage loop, r₂ represents injected damping of a current loop, r₁ and r₂ are undetermined parameters, L represents an inductance value of a filtering inductor, and C represents a capacitance value of a filtering capacitor;
step 5: defining the state variable matrix x, an expected state variable matrix x_{d}, and a closed loop Hamiltonian function H_{d}(x−x_{d});
step 6: establishing an expected closed loop Hamiltonian model based on the inner-loop Hamiltonian model, the nonlinear observer, and the closed loop Hamiltonian function, wherein an expression of the expected closed loop Hamiltonian model is as follows:
$$\dot{x} - {\dot{x}}_{d} = [ {J}_{d} ( x ) - {R}_{d} ( x ) ] \frac{\partial {H}_{d} ( x - {x}_{d} )}{\partial ( x - {x}_{d} )} - {g}_{p} ( \hat{p} - p ) ;$$
wherein \dot{x} represents a differential of the state variable matrix, and \dot{x}_{d} represents a differential of the expected state variable matrix; and
designing a passivity-based controller for the inner voltage and current loops of the grid-forming inverter based on the expected closed loop Hamiltonian model, such that the grid-forming inverter station satisfies passivity, ensuring stable operation of the grid-forming inverter station; and
step 7: designing a parameter adaptation law for the injected damping r₁ of the voltage loop and the injected damping r₂ of the current loop by using a pole placement method, assuming that the injected damping r₂ of the current loop and L_{g} of the grid inductor are known quantities, deriving two types of constraint relationships of the injected damping of the voltage loop with respect to the r₁, defining a first constraint relationship as r₁=f(r₂,L_{g}), defining a second constraint relationship as r₁=g(r₂, L_{g}), based on r₁=f(r₂, L_{g}) and r₁=g(r₂,L_{g}), calculating corresponding values that are of the r₁ and the r₂ and satisfy expected dynamic performance of each inverter in the grid-forming inverter station under corresponding different L_{g} of the grid inductor, thereby achieving distributed coordinated control among the inverters.

9. The passivity-based distributed coordinated control method for the grid-forming inverter station according to claim 8, wherein an expression of the inner-loop mathematical model in the step 1 is as follows:
$$\{ \begin{matrix}L \frac{{di}_{d}}{dt} = - {r}_{f} {i}_{d} + ω {Li}_{q} + {v}_{d} - {v}_{Cd} - {γ}_{vd} \\ L \frac{{di}_{q}}{dt} = - {r}_{f} {i}_{q} - ω {Li}_{d} + {v}_{q} - {v}_{Cq} - {γ}_{vq} \\ C \frac{{dv}_{Cd}}{dt} = {i}_{d} - {i}_{gd} + ω {Cv}_{Cq} - {γ}_{id} \\ C \frac{{dv}_{Cq}}{dt} = {i}_{q} - {i}_{gq} - ω {Cv}_{Cd} - {γ}_{iq}\end{matrix} ;$$
wherein L represents the inductance value of the filtering inductor, C represents the capacitance value of the filtering capacitor, i_{d} represents a d-axis component of an output current of the inverter, i_{q} represents a q-axis component of the output current of the inverter,
$$\frac{{di}_{d}}{dt}$$
represents a derivative of the d-axis component of the output current of the inverter with respect to time,
$$\frac{{di}_{q}}{dt}$$
represents a derivative of the q-axis component of the output current of the inverter with respect to the time, v_{Cd} represents a d-axis component of an output voltage of the inverter, v_{Cq} represents a q-axis component of the output voltage of the inverter,
$$\frac{{dv}_{Cd}}{dt}$$
represents a derivative of the d-axis component of the output voltage of the inverter with respect to the time,
$$\frac{{dv}_{Cq}}{dt}$$
represents a derivative of the q-axis component of the output voltage of the inverter with respect to the time, ω represents an angular frequency, i_{gd} represents a d-axis component of a grid-side current, i_{gq} represents a q-axis component of the grid-side current, r_{f} represents a parasitic resistance value of the filtering inductor, v_{d} represents a d-axis component of a modulation voltage of the inverter, v_{q} represents a q-axis component of the modulation voltage of the inverter, γ_{vd} represents a d-axis component of a disturbance of the voltage loop, γ_{vq} represents a q-axis component of the disturbance of the voltage loop, γ_{id} represents a d-axis component of a disturbance of the current loop, and γ_{iq} represents a q-axis component of the disturbance of the current loop.

10. The passivity-based distributed coordinated control method for the grid-forming inverter station according to claim 9, wherein an expression of the inner-loop Hamiltonian model in the step 2 is as follows:
$$\dot{x} = [ J ( x ) - R ( x ) ] \frac{\partial H ( x )}{\partial x} + {g}_{c} {u}_{c} + {g}_{e} {u}_{e} + {g}_{p} p ;$$
wherein u_{c} represents a control input matrix, g_{c} represents a coefficient matrix of the control input matrix, uₑ represents an external input matrix, gₑ represents a coefficient matrix of the external input matrix, p represents an unknown disturbance matrix, gₚ represents a coefficient matrix of the unknown disturbance matrix, H(x) represents the Hamiltonian function, J(x) represents the interconnection matrix, and R(x) represents the damping matrix;
expressions of the interconnection matrix J(x) and the damping matrix R(x) are as follows:
$$J ( x ) = [ \begin{matrix}0 & ω / L & - 1 / ( LC ) & 0 \\ - ω / L & 0 & 0 & - 1 / ( LC ) \\ 1 / ( LC ) & 0 & 0 & ω / C \\ 0 & 1 / ( LC ) & - ω / C & 0\end{matrix} ] ; \\ R ( x ) = ( \begin{matrix}{r}_{f} / {L}^{2} & 0 & 0 & 0 \\ 0 & {r}_{f} / {L}^{2} & 0 & 0 \\ 0 & 0 & 0 & 0 \\ 0 & 0 & 0 & 0\end{matrix} ) ;$$
and
the Hamiltonian function H(x) is defined as follows:
$$H ( x ) = \frac{1}{2} {Li}_{d}^{2} + \frac{1}{2} {Li}_{q}^{2} + \frac{1}{2} {Cv}_{Cd}^{2} + \frac{1}{2} {Cv}_{Cq}^{2} .$$

11. The passivity-based distributed coordinated control method for the grid-forming inverter station according to claim 10, wherein an expression of the nonlinear observer in the step 3 is as follows:
$$\{ \begin{matrix}{x}^{\dot{ˆ}} = [ {J}_{d} ( x ) - {R}_{d} ( x ) ] \frac{\partial H ( x )}{\partial x} + {g}_{c} {u}_{c} + {g}_{e} {u}_{e} + {g}_{p} \hat{p} - {k}_{1} ( \hat{x} - x ) \\ \dot{\hat{p}} = ( - {k}_{1} {k}_{2} - {g}_{p} ) ( \hat{x} - x ) - {k}_{2} ( {x}^{\dot{ˆ}} - \dot{x} ) + {g}_{p} \frac{\partial {H}_{d} ( x - {x}_{d} )}{\partial ( x - {x}_{d} )}\end{matrix} ;$$
wherein \hat{x} represents an observed value of the state variable matrix, \hat{\dot{x}} represents a differential of the observed value of the state variable matrix, \hat{p} represents an observed value of the unknown disturbance matrix, \hat{\dot{p}} represents a differential of the observed value of the unknown disturbance matrix, k₁ represents a first observer gain coefficient, k₂ represents a second observer gain coefficient, J_{d}(x) represents the expected interconnection matrix, and R_{d}(x) represents the expected damping matrix.

12. The passivity-based distributed coordinated control method for the grid-forming inverter station according to claim 11, wherein the state variable matrix x, the expected state variable matrix x_{d}, and the closed loop Hamiltonian function H_{d}(x−x_{d}) in the step 5 are defined as follows:
$$\{ \begin{matrix}x = {( {i}_{d} , {i}_{q} , {v}_{Cd} , {v}_{Cq} )}^{T} \\ {x}_{d} = {( {i}_{d}^{*} , {i}_{q}^{*} , {v}_{Cd}^{*} , {v}_{Cq}^{*} )}^{T}\end{matrix} ;$$
$${H}_{d} ( x - {x}_{d} ) = \frac{1}{2} {( x - {x}_{d} )}^{T} Q ( x - {x}_{d} ) ;$$
wherein
$${i}_{d}^{*}$$
represents an expected d-axis component of the output current of the inverter,
$${i}_{q}^{*}$$
represents an expected q-axis component of the output current of the inverter,
$${v}_{Cd}^{*}$$
represents an expected d-axis component of the output voltage of the inverter,
$${v}_{Cq}^{*}$$
represents an expected q-axis component of the output voltage of the inverter, superscript T represents matrix transposition, Q represents a filter parameter matrix, and Q=diag(L,L,C,C).

13. The passivity-based distributed coordinated control method for the grid-forming inverter station according to claim 12, wherein the step 7 specifically comprises following steps:
step 7.1: establishing a voltage-loop open loop continuous domain transfer function Gᵥ(s) and a current-loop open loop continuous domain transfer function G_{c}(s) of the passivity-based controller for the inner voltage and current loops, wherein expressions of the voltage-loop open loop continuous domain transfer function and the current-loop open loop continuous domain transfer function are as follows:
$$\{ \begin{matrix}{G}_{v} ( s ) = {r}_{1} + sC \\ {G}_{c} ( s ) = {r}_{2} + sL\end{matrix} ;$$
wherein s represents a Laplace operator; and
multiplying the Gᵥ(s) and the G_{c}(s) to obtain an overall open loop continuous domain transfer function Gᵢ(s) of the passivity-based controller for the inner voltage and current loops, wherein an expression of the overall open loop continuous domain transfer function is as follows:
Gᵢ(s)=r₁r₂+(r₁L+r₂C)s+LCs²;
step 7.2: discretizing the overall open loop continuous domain transfer function Gᵢ(s) of the passivity-based controller for the inner voltage and current loops by using a backward Euler method, and obtaining an overall open loop discrete domain transfer function Gᵢ(z) of the passivity-based controller for the inner voltage and current loops, wherein an expression of the overall open loop discrete domain transfer function is as follows:
$${G}_{i} ( z ) = [ {r}_{1} {r}_{2} {T}_{s}^{2} + ( {r}_{1} L + {r}_{2} C ) ( 1 - {z}^{- 1} ) {T}_{s} + {LC ( 1 - {z}^{- 1} )}^{2} ] / {T}_{s}^{2} ;$$
wherein Tₛ represents a sampling period, z represents a discrete domain variable, z=e^{-sT}^{ₛ}, and s represents the Laplace operator;
step 7.3: establishing a discrete domain transfer function G_{LCL}(z) of an inverter-side current with respect to the output voltage of the inverter, wherein an expression of the discrete domain transfer function is as follows:
$${G}_{LCL} ( z ) = \frac{a ( {z}^{- 1} - 2 {z}^{- 2} b + {z}^{- 3} )}{1 + ( 2 cos {ω}_{r} {T}_{s} + 1 ) ( - {z}^{- 1} + {z}^{- 2} ) - {z}^{- 3}} ;$$
wherein ωᵣ represents a resonant frequency, namely
$${ω}_{r} = \sqrt{\frac{L + {L}_{g}}{{LL}_{g} C}} ;$$
a represents a first simplification coefficient, namely
$$a = \frac{L {ω}_{r} {T}_{s} + {L}_{g} sin {ω}_{r} {T}_{s}}{{ω}_{r} L ( L + {L}_{g} )} ;$$
b represents a second simplification coefficient, namely
$$b = \frac{L {ω}_{r} {T}_{s} cos {ω}_{r} {T}_{s} + {L}_{g} sin {ω}_{r} {T}_{s}}{L {ω}_{r} {T}_{s} + {L}_{g} sin {ω}_{r} {T}_{s}} ;$$
and L_{g} represents an inductance value of the grid inductor;
step 7.4: calculating a closed loop discrete domain transfer function G(z) of the controller based on the overall open loop discrete domain transfer function Gᵢ(z) of the passivity-based controller for the inner voltage and current loops in the step 7.2, and the discrete domain transfer function G_{LCL}(z) of the inverter-side current with respect to the output voltage of the inverter in the step 7.3, wherein an expression of the closed loop discrete domain transfer function is as follows:
G(z)=z⁻¹Gᵢ(z)G_{LCL}(z)/[1+z⁻¹Gᵢ(z)G_{LCL}(z)];
step 7.5: obtaining a closed loop discrete domain characteristic equation A_{c}(z⁻¹) of the controller based on the closed loop discrete domain transfer function G(z) of the controller:
$${A}_{c} ( {z}^{- 1} ) = 1 - ( 2 cos {ω}_{r} {T}_{s} + 1 ) {z}^{- 1} + ( 1 + 2 cos {ω}_{r} {T}_{s} + {ar}_{1} {r}_{2} + a ( {r}_{1} L + {r}_{2} C ) / {T}_{s} + aLC / {T}_{s}^{2} ) {z}^{- 2} + ( - 1 - 2 ab ( {r}_{1} {r}_{2} + ( {r}_{1} L + {r}_{2} C ) / {T}_{s} + LC / {T}_{s}^{2} ) - a ( {r}_{1} L + {r}_{2} C ) / {T}_{s} - 2 aLC / {T}_{s}^{2} ) {z}^{- 3} + ( a ( {r}_{1} {r}_{2} + ( {r}_{1} L + {r}_{2} C ) / {T}_{s} + LC / {T}_{s}^{2} ) + 2 ab ( {r}_{1} L + {r}_{2} C ) / {T}_{s} + ( 4 ab + a ) LC / {T}_{s}^{2} ) {z}^{- 4} + ( - a ( {r}_{1} L + {r}_{2} C ) / {T}_{s} - ( 2 a + 2 ab ) LC / {T}_{s}^{2} ) {z}^{- 5} + ( aLC / {T}_{s}^{2} ) {z}^{- 6 ;} ;$$
step 7.6: selecting an expected pole of the closed loop discrete domain characteristic equation of the controller, and defining a first dominant pole z₁, a second dominant pole z₂, a third non-dominant pole z₃, a fourth non-dominant pole z₄, a fifth non-dominant pole z₅, and a sixth non-dominant pole z₆ that are expressed are as follows:
$$\{ \begin{matrix}{z}_{1} = {e}^{- {ξω}_{n} {T}_{s}} [ cos ( {ω}_{n} {T}_{s} \sqrt{1 - {ξ}^{2}} ) + j sin ( {ω}_{n} {T}_{s} \sqrt{1 - {ξ}^{2}} ) ] \\ {z}_{2} = {e}^{- {ξω}_{n} {T}_{s}} [ cos ( {ω}_{n} {T}_{s} \sqrt{1 - {ξ}^{2}} ) + j sin ( {ω}_{n} {T}_{s} \sqrt{1 - {ξ}^{2}} ) ] \\ {z}_{3} = {e}^{- m {ξω}_{n} {T}_{s}} \\ {z}_{4} = {e}^{- m {ξω}_{n} {T}_{s}} \\ {z}_{5} = {e}^{- m {ξω}_{n} {T}_{s}} \\ {z}_{6} = {e}^{- m {ξω}_{n} {T}_{s}}\end{matrix} ;$$
wherein ξ represents a damping ratio, ωₙ represents a natural frequency, j represents an imaginary unit, and m represents a non-dominant pole coefficient;
step 7.7: obtaining an expected closed loop discrete domain characteristic equation Aₘ(z⁻¹) of the controller based on the expected pole of the discrete domain characteristic equation in the step 7.6, wherein an expression of the expected closed loop discrete domain characteristic equation is as follows:
Aₘ(z⁻¹)=[z²−2e^{-ξω}^{ₙ}^{T}^{ₛ} cos(ωₙ\sqrt{1−ξ²}Tₛ)z+e^{-2ξω}^{ₙ}^{T}^{ₛ}](z−e^{-mξω}^{ₙ}^{T}^{ₛ})⁴;
step 7.8: based on the closed loop discrete domain characteristic equation of the controller in the step 7.5 and the expected closed loop discrete domain characteristic equation of the controller in the step 7.7, setting Aₘ(z⁻¹)=A_{c}(z⁻¹), implementing pole placement, and establishing a mathematical relationship between the injected damping r₁ of the voltage loop, the injected damping r₂ of the current loop, and the L_{g} of the grid inductor;
assuming that the injected damping r₂ of the current loop and the L_{g} of the grid inductor are known quantities, deriving two types of constraint relationships of the injected damping of the voltage loop with respect to the r₁, and defining a first constraint relationship as r₁=f(r₂,L_{g}), wherein an expression of the first constraint relationship is as follows:
$${r}_{1} = \frac{\begin{matrix}{e}^{- 2 {ξω}_{n} {T}_{s}} + 8 {e}^{- ( 1 + m ) {ξω}_{n} {T}_{s}} cos ( {ω}_{n} {T}_{s} \sqrt{1 - {ξ}^{2} )} + \\ 6 {e}^{- 2 m {ξω}_{n} {T}_{s}} - ( 1 + 2 cos ( {ω}_{r} {T}_{s} ) + \frac{aLC}{{T}_{s}^{2}} + \frac{{ar}_{2} C}{{T}_{s}} )\end{matrix}}{{ar}_{2} + aL / {T}_{s}} ;$$
and
defining a second constraint relationship as r₁=g(r₂,L_{g}), wherein an expression of the second constraint relationship is as follows:
$${r}_{1} = \frac{\begin{matrix}12 {e}^{- ( 2 m + 1 ) {ξω}_{n} {T}_{s}} cos ( {ω}_{n} \sqrt{1 - {ξ}^{2}} {T}_{s} ) + 4 {e}^{- ( m + 2 ) {ξω}_{n} {T}_{s}} + \\ 4 {e}^{- 3 m {ξω}_{n} {T}_{s}} + 1 + \frac{2 {abr}_{2} C}{{T}_{s}} + \frac{2 abLC}{{T}_{s}^{2}} + \frac{{ar}_{2} C}{{T}_{s}} + \frac{2 aLC}{{T}_{s}^{2}}\end{matrix}}{2 {abr}_{2} + 2 abL / {T}_{s} + aL / {T}_{s}} ;$$
and
step 7.9: based on the two types of constraint relationships r₁=f(r₂,L_{g}) and r₁=g(r₂,L_{g}) in the step 7.8, calculating corresponding values that are of the r₁ and the r₂ and satisfy expected dynamic performance of each inverter in the grid-forming inverter station under corresponding different L_{g} of the grid inductor, thereby achieving the distributed coordinated control among the inverters.
